(19) United States
(12) Patent Application Publication
(10) Pub. No.: US 2025/0005166 A1
(43) Pub. Date: Jan. 2, 2025

(54) DETECTING SECURITY VULNERABILITIES THROUGH DYNAMIC TESTING WITH CANARY PROGRAMS

(71) Applicant: INTERNATIONAL BUSINESS MACHINES CORPORATION, ARMONK, NY (US)

(72) Inventors: MICHAEL PAGE KASPER, WAPPINGERS FALLS, NY (US); PETER G. SPERA, PLEASANT VALLEY, NY (US)

(21) Appl. No.: 18/344,811

(22) Filed: Jun. 29, 2023

(51) Int. Cl. G06F 21/57; G06F 21/55; G06F 21/56

(52) U.S. Cl. CPC G06F 21/577; G06F 21/554; G06F 21/566

(57) ABSTRACT

Detecting security vulnerabilities through dynamic testing with canary programs is disclosed, including issuing, by a test tool, a call to an application one or more parameters that reference a canary program; determining, by the test tool, whether the application called the canary program; and logging, by the test tool, a security vulnerability of the application in response to determining that the application called the canary program.

### BACKGROUND

### Field of the Disclosure

The field of the disclosure is security testing, or, more specifically, methods, apparatus, and products for detecting security vulnerabilities through dynamic testing with canary programs.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

A secure computing platform presents a complex environment with many authorized interfaces and a large amount of authorized code. Authorized code or programs may be provided as part of the operating system or as part of specific products. Some authorized code may be provided by software vendors or created by customers. Without a cumbersome analysis of large amounts of documentation on the authorized code, it is difficult to identify all of the security vulnerabilities of the code. While automated code scanners can dynamically test authorized code, they do not attempt to detect when that authorized code allows the caller to specify the name of a program to be loaded and called by an authorized program, thus allowing a user to cause an indirect privilege escalation of the called program, which may behave in unexpected ways.

### SUMMARY

Methods, apparatuses, and products for detecting security vulnerabilities through dynamic testing with canary programs according to various embodiments are disclosed. Detecting security vulnerabilities through dynamic testing with canary programs can include: issuing, by a test tool, a call to an application with one or more parameters that reference a canary program; determining, by the test tool, whether application called the canary program; and logging, by the test tool, a security vulnerability of the application in response to determining that the application called the canary program.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 a block diagram of an example computing system configured for detecting security vulnerabilities through dynamic testing with canary programs in accordance with embodiments of the present disclosure.

FIG. 2 is a block diagram of an example platform for detecting security vulnerabilities through dynamic testing with canary programs according to some embodiments of the present disclosure.

FIG. 3 is a flowchart of an example method for detecting security vulnerabilities through dynamic testing with canary programs according to some embodiments of the present disclosure.

FIG. 4 is a flowchart of an example method for detecting security vulnerabilities through dynamic testing with canary programs according to some embodiments of the present disclosure.

### DETAILED DESCRIPTION

Computing systems may contain large amounts of authorized code that can access sensitive system services and resources. Some of this code is provided as part of the operating system or as part of specific products, while some is provided by software vendors or created by customers. The computing system's operating system and a variety of security facilities may provide authorization for such code. For example, z/OS operating system provides many different forms of authorization. One form of authorization is when a library or data set containing programs has authorization from an authorized program facility (APF) and is marked as ‘APF-authorized.’ This means programs in that library can be called by other APF-authorized libraries; however, it does not mean the APF-authorized program will always run in an authorized state such as system key, supervisor state, or with security control block authorizations (e.g., the job step control block authorization (JSCBAUTH) in z/OS) turned on. It only means that such a program could be loaded and called by a program running in one of those authorized states.

As a result, it is up to the authorized program that is calling the other program to call that program in a safe and expected way. The called program might not be designed to account for every possible input or the security implications of that input, since it will not run authorized if called by an unauthorized user or called in an unauthorized state. Unfortunately, this concept is not always well understood, which leads to authorized programs allowing unauthorized users to specify the names of programs that the authorized program will load and call on their behalf, without any restrictions. To provide one example, an authorized program may allow a user to specify a program to call as an exit routine. In a simple case, a user might specify a user exit that writes an error message to an operator console; however, an authorized program could also provide an interface that allows the user to specify any other program to be called as an exit. This is dangerous because a called program might not have been designed to be called that way, but by doing so the authorized program calling the program is placing an undue burden on the called program to handle any possible input or calling environment. The solution to this type of security vulnerability is often for the authorized program to limit the names of the programs that can be specified by the unauthorized user to programs from a system or administrator-controlled list, or otherwise prevent users from specifying the name at all. However, finding these dangerous authorized programs is not easy, and no known automated methods exist for locating their existence, other than reading through product documentation or asking experts.

While testing tools such as code scanners (e.g., the z/OS Authorized Code Scanner (zACS)) are capable of dynamically testing authorized code, they do not attempt to detect when that authorized code allows the caller to specify the name of a program to be loaded and called. Such behavior can introduce an indirect privilege escalation vulnerability, which is indirect in the sense that the program is in an authorized library but not intended to be called this way. This could cause an error leading to a branch to an unintended location or overlay of storage, and an unauthorized user could take advantage to indirectly get control in an authorized state.

In accordance with embodiments of the present disclosure, security testing of authorized code is facilitated using canary programs that are specified by name as parameters for input when calling authorized programs and services. These canary programs are configured to signal an alarm when the canary program is called, especially when called in an authorized state such as system key, supervisor state, or with JSCBAUTH on. For example, the canary program can update a table to indicate the time and circumstances where it was called, including the calling program and parameter that led it to be called (if that can be determined). Dynamic testing tools, including local and web application testing tools, can check this table and compare the time or other information to determine which test led to the privilege escalation. Once an indirect privilege escalation vulnerability is detected, a report may be issued detailing the vulnerability. Remedial actions may include removing authorization from the library, deactivating the product responsible, or deleting and uninstalling the vulnerable code if alternative products are available.

In a particular implementation, during a dynamic test of an authorized program or service, either with a local testing tool that calls the program or a network scanning tool that sends requests to a network interface (e.g., a web application scanning tool that sends HTTPS requests to a web server), the dynamic testing tool is supplied with a module name or list of names to add to its request strings. In a first example, the string might simply be the name of a canary program that is repeated to fill the parameters. The dynamic testing tool can check the table after each test attempt to determine if the canary program was called and saves that information to keep track of which attempts led to the privilege escalation. In a second example, a sequence can be used where each supplied parameter references a different canary program. The dynamic testing tool can check the table after each test attempt to determine if any of the canary programs were called and determine the offset in the parameter string based on the location in the parameter string of the canary program that was called. Additional information that can be provided in the table includes the time of the call, program name, load module and offset that called it, the home, primary, and secondary address space this occurred in, as well as whether it was running in supervisor state, system key, with JSCBAUTH on, or any combination. Once the dynamic testing tool identifies a potential vulnerability it can create a report to show this information to the user in a data set or interface that would only be accessible to authorized users due to the sensitivity of the information. Using this report, software vendors may be contacted for a solution to the indirect privilege escalation vulnerability in their program. The canary program may also be configured to optionally capture system dumps when called to provide even more information to show to software vendors to find the root cause of the problem.

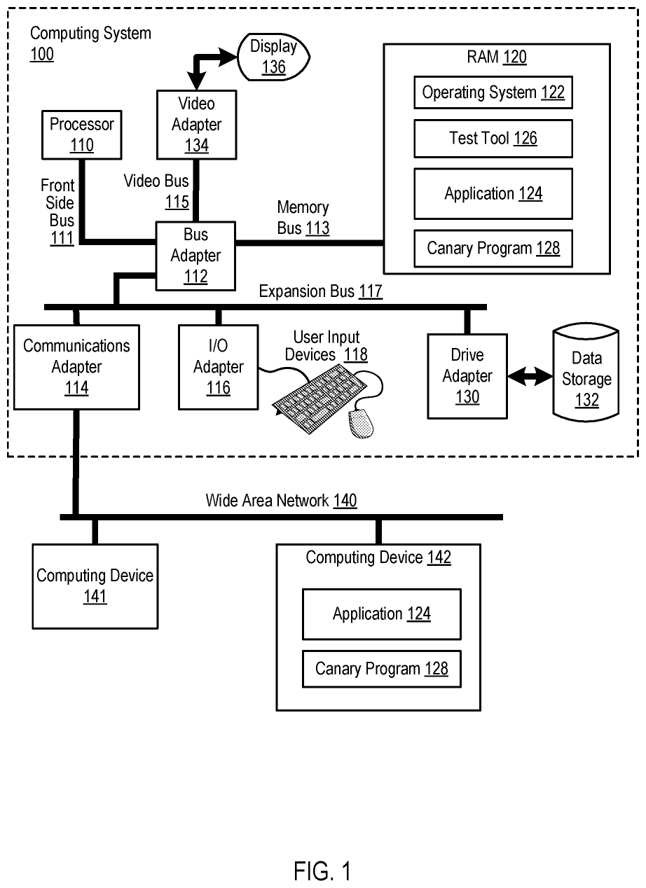

Exemplary apparatus and systems for detecting security vulnerabilities through dynamic testing with canary programs in accordance with the present disclosure are described with reference to the accompanying drawings, beginning with FIG. 1. FIG. 1 sets forth a block diagram of automated computing machinery comprising an exemplary computing system 100 configured for detecting security vulnerabilities through dynamic testing with canary programs according to embodiments of the present disclosure. The computing system 100 of FIG. 1 includes at least one computer processor 110 or ‘CPU’ as well as random access memory (‘RAM’) 120 which is connected through a high speed memory bus 113 and bus adapter 112 to processor 110 and to other components of the computing system 100.

Stored in RAM 120 is an operating system 122. Operating systems useful in computers configured for detecting security vulnerabilities through dynamic testing with canary programs according to embodiments of the present disclosure include z/OS™, UNIX™, Linux™, Microsoft Windows™, AIX™, and others as will occur to those of skill in the art. The operating system 122 in the example of FIG. 1 is shown in RAM 120, but many components of such software typically are stored in non-volatile memory also, such as, for example, on data storage 132, such as a disk drive. Also stored in RAM is an application 124 under test.

Also stored in RAM is a canary program 128. Also stored in RAM is a test tool 126 configured for detecting security vulnerabilities through dynamic testing with canary programs according to embodiments of the present disclosure. The test tool 126 is a computer program configured to identify potential security risks, security bypasses, and unexpected behavior in the application 124. In some examples, the test tool 126 is embodied in a set of computer program instructions that, when executed by the processor 110, cause the computing system 100 to carry out the automated steps of: issuing, by a test tool, a call to an application with one or more parameters that reference the canary program; determining, by the test tool, whether the application called the canary program; and logging, by the test tool, a security vulnerability of the application in response to determining that the application called the canary program.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (‘I/O’) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications. The communications adapter 114 of FIG. 1 is communicatively coupled to a wide area network 140 that also includes other computing devices, such as computing devices 141 and 142 as shown in FIG. 1. In some examples, a remote computing device such as computing device 142 hosts the application 124 under test and the canary program 128.

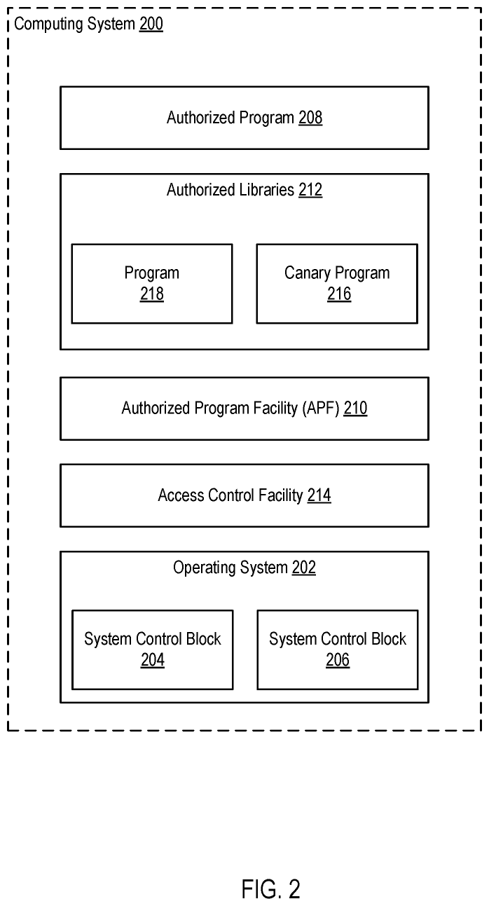

For further explanation, FIG. 2 sets forth a flowchart illustrating an example computing system detecting security vulnerabilities through dynamic testing with canary programs according to embodiments of the present disclosure. The example system 200 includes an operating system 202. The operating system 202 may include or utilize various system control blocks 204, 206 that include security settings used to control whether a user, program, or environment has special privileges or authorizations. For example, these security settings can be used to escalate the privileges of a particular user or bypass password protection for a dataset. In the z/OS operating system, for example, the ACEE control block can control whether someone has special privileges or operator privileges for a particular address space, and the JSCB can control whether someone is running authorized or in bypass mode for dataset access (e.g., the JSCBAuth bit is set for the authorized program). If a program is authorized, it can change privileges for a user, job, or environment and bypass security measures using control block settings. While control blocks should only be modified through security services and products such as an access control facility 214 (e.g., the resource access control facility (RACF) in the z/OS operating system), an authorized program can switch into system key and modify the settings directly. The operating system 202 may include authorized programs and services, including supervisor calls (SVCs) program calls (PCs), and exit routines. Access to these functions must be restricted to only authorized programs to avoid compromising the security and integrity of the system.

The example system 200 includes authorized programs such as authorized program 208. The authorized program 208 may be an authorized program or service of the operating system 202 or an installed program that is included in an authorized library such as an APF authorized library 212, as will be explained in more detail below. An authorized program can run with an elevated privilege to access virtually any resource. For example, an authorized program can put itself into supervisor state or a system key, it can modify system control blocks, it can execute privileged instructions (while in supervisor state), and it can turn off logging. Thus, such authorization must be given out sparingly and monitored carefully. In the z/OS operating system, the system considers a program authorized if the program has one or more of the following characteristics: runs in supervisor state (bit 15 of the program status word (PSW) is zero); runs with PSW key 0-7 (bits 8-11 of the PSW are in the range 0-7); runs under an APF-authorized job step task. In some examples, an authorized program is linked to an access control code. In z/OS, for example, an authorized program may be linked with SETCODE AC (1). A program linked to AC (1) can use the MODESET service to switch to a supervisor state and system key. This is in contrast to a program that is not AC (1) which cannot make use of the MODESET service to switch to a supervisor state and system key. While in supervisor state, a program can execute restricted machine instructions. In storage protection (or system) key 0, a program can access all main storage of the computer. This means that it is possible for authorized programs to circumvent all standard z/OS security mechanisms and gain access to secured data.

An authorized program facility (APF) 210 is used to allow an installation to identify system or user programs that can use sensitive system functions. In some examples, to maintain system security and integrity a program must be authorized by the APF before it can access restricted functions such as supervisor calls (SVC) or SVC paths. The APF helps to avoid integrity exposures as the installation identifies which libraries contain special functions or programs. These libraries are then called APF authorized libraries 212. An installation can use the APF to identify system or user programs that can use sensitive system functions. For example, the APF allows an installation to restrict the use of sensitive SVC routines to APF-authorized programs and allow the system to fetch modules in an authorized job step task only from authorized libraries. In the z/OS operating system, for example, APF-authorized programs must reside in system authorized libraries (e.g., SYS1.LINKLIB; SYS1.SVCLIB, SYS1.LPALIB) or an authorized libraries protected by an access control facility 214 (e.g., RACF in the z/OS operating system). Authorized libraries are defined in an APF list, or in the link pack area. Any module in the link pack area will be treated by the system as though it came from an APF-authorized library. The APF can also prevent authorized programs from using a load module that is not in an APF-authorized library.

In some examples, when the operating system 202 starts a new job, the first program specified must be linked to a certain access control code (e.g., AC (1)) and come from an authorized library for the job to run authorized. In one example, the authorized program 208 is an authorized program with job step authority. That program and subsequent programs in that step can execute programs from authorized libraries (e.g., an APF-authorized library) that do not have job-step authority. These programs, too, can run authorized. Thus, if the authorized program 208 can be manipulated to call a program with elevated privilege or with unexpected input, this presents a serious security vulnerability.

For purposes of illustration, the authorized library 212 may include another program 218 that can be called by the authorized program 208 (e.g., because the program 218 is an APF-authorized program). However, as noted above, where the authorized program 208 is running with elevated privileges, calling program 218 may indirectly escalate the privileges of program 218. Security vulnerabilities may arise if the program 218 in the authorized library 212 does not perform certain checks before taking an action that requires environmental privileges, such as writing to storage, branching to an address, or modifying control block settings. For example, the program 218 might expect to be called in unauthorized environments where it does not need to check the inputs or the environment because any errors will be harmless, and because it is not supposed to be running with any authorization when called in an unauthorized environment. As another example, the program 218 might expect to be called in an authorized environment but assumes the authorized caller has checked the inputs or environment, so it should not need to check any of those things itself when called in an authorized environment. Thus, if the user is allowed to specify the program 218 and the inputs for that program 218 that is called by the authorized program 208, the program 218 might perform unexpectedly or could be manipulated to circumvent security measures.

To test for such vulnerabilities in the authorized program 208, the example computing system 200 also includes a canary program 216 for testing whether the authorized program 208 could call another program from an authorized library 212 in an unexpected way. As will be explained in greater detail below, if some input to the authorized program 208 can result in the authorized program 208 calling the canary program 216, then a security vulnerability is present.

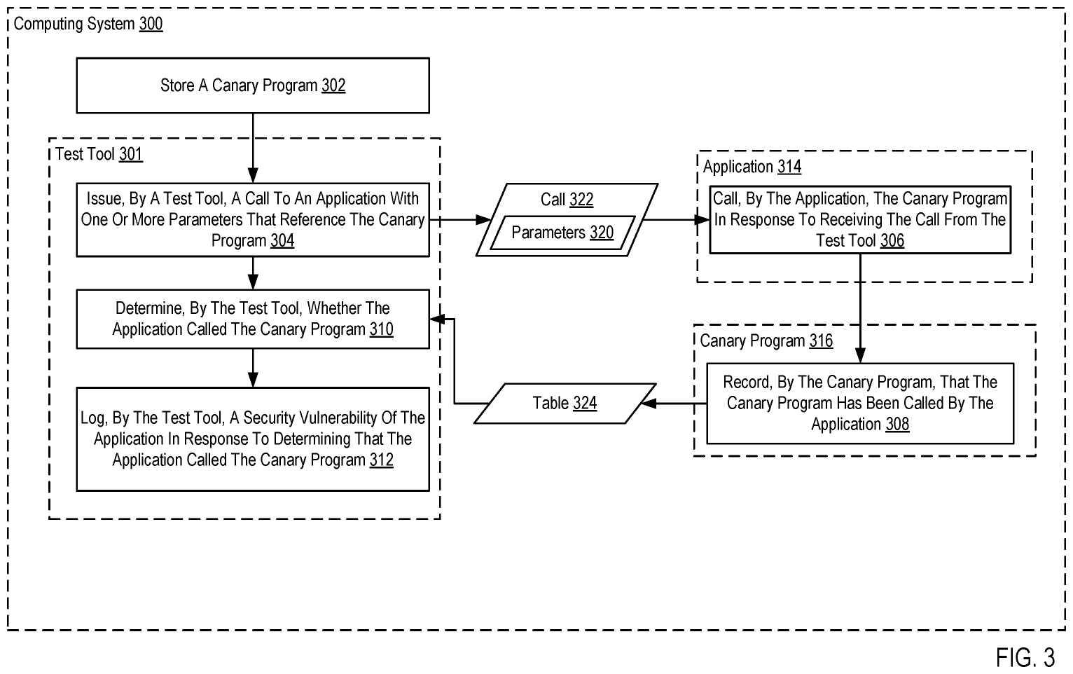

For further explanation, FIG. 3 sets forth a flowchart illustrating an example method of detecting security vulnerabilities through dynamic testing with canary programs according to embodiments of the present disclosure. The example of FIG. 3 is described in the context of an example computing system 300 (e.g., the example computing system 100 of FIG. 1 or the example computing system 200 of FIG. 2). In some examples, the example computing system may be based on, for example, the z/Architecture offered by International Business Machines (IBM). However, the use of such an architecture is provided only as one example for the computer system 300 and is not intended to limit the scope of the present disclosure. For example, the computing system may be a web application host. In some examples, the computing system 300 includes an operating system (e.g., the operating system 122 of FIG. 1) that implements a security or access control facilities that protects resources such as restricted areas of memory by granting access only to authorized users of the protected resources. In a particular example, the operating system may be the z/OS operating system. In such examples, the access control facilities may include the APF and RACF. The operating system may employ one or more security-related system control blocks, such as the ACEE or the JSCB of the z/OS Operating System.

The example computing system 300 also includes one or more applications 314 such as an authorized program or a network interface application such as a web application or other network interface applications such as a terminal emulator application (e.g., a TN3270 Telnet application) or a virtual network interface. An authorized program may be linked to an authorization code such that the operating system grants the authorized program access to sensitive resources and functions of the computing system. Programs called by the authorized program must also be from an authorized library. If the authorized program is running in an authorized state in which its privileges are elevated, a program that is called by the authorized program will also run with those elevate privileges. Thus, if the authorized program can be manipulated to call a program with elevated privilege or with unexpected input, this presents a serious security vulnerability. Similarly, a web application may provide a web application interface through which parameters can be supplied via hypertext transfer protocol (HTTP) requests. Thus, if the web application can be manipulated to call a program that a user is not authorized to access, this presents a serious security vulnerability. Similarly, another network interface application may provide a terminal emulator for a command line interface through which parameters can be supplied. Thus, if the network interface application can be manipulated to call a program that a user is not authorized to access, this presents a serious security vulnerability. To identify such vulnerabilities, the computing system 300 also includes a test tool 301. Although shown as part of the same computing system 300 in FIG. 3, the test tool 301 may be local to or remote from the physical computing device that hosts the application 314 and the canary program 316. For example, when the application 314 is an authorized program, the test tool 301 may run on the same computing device as the application 314. When the application 314 is a web application, the test tool 301 may be remote from the server that hosts the web application.

The test tool 301 is configured for dynamic testing of the application 314. The security analysis tool supplies inputs to the application 314 and monitors the behavior of the application to assess security vulnerabilities. For example, in the case of authorized programs, the test tool 301 can supply a list of parameters or a parameter file to an authorized program and determine the output of the authorized program or, if the call to the authorized program results in an error condition, the circumstances in which the authorized program ended abnormally. In many cases, the input to the application 314 is randomly generated and provided to the application 314 without any prior knowledge of what parameters are expected by the application 314. For example, an authorized program might allow a user to dynamically select a program to execute in an exit routine by referencing that program in a supplied parameter. The test tool 301 does not know in advance whether the authorized program does, in fact, allow for this behavior and does not know which parameter (e.g., an offset in a parameter string) is used for specifying a program to call (e.g., through an exit).

The method of FIG. 3 includes storing 302 a canary program 316. In some examples, the canary program 316 is a module of computer-executable instructions that, when executed, signals an alarm that the canary program 316 has been called. For example, the canary program may be configured to update a data structure (e.g., a table) or provide some other signal indicating the canary program has been called, which can be observed by the security analysis tool or a test engineer to identify that the canary program has been called. When the application 314 is an authorized program, the canary program 316 is stored in the authorized library prior to testing the authorized program to make the canary program 316 available as a program that can be called by the authorized program. The authorized library may be, for example, a link pack area, nucleus, or APF-authorized library of the z/OS operating system. When the application 314 is a web application or other network interface application, the canary program may be stored on the host of the network interface application.

The method of FIG. 3 also includes issuing 304, by the test tool 301, a call 322 to the application 314 with a list of parameters 320 that references the canary program 316. In some examples, when the application 314 is an authorized program, the test tool 301 issues 304 the call 322 to the authorized program with one or more parameters 320 that are provided through a call in a command line interface. For example, the parameters 320 may be provided as a parameter string. In other examples, the test tool 301 issues 304 the call 322 to the authorized program with one or more parameters 320 that are provided in a parameter file or other configuration file that includes the list of parameters 320. At least one parameter in the list of parameters 320 references the canary program 316. In some examples, the canary program 316 is referenced by including the name of the canary program 316 or the name of the load module that includes the canary program 316. In other implementations, when the application 314 is a network interface application such as a web application, the test tool 301 issues 304 the call 322 to the web application with one or more parameters 320 that are provided through an HTTP request such as a GET or POST request. In yet other implementations, when the application 314 is a network interface application such as a terminal application, the test tool 301 issues 304 the call 322 with one or more parameters 320 that are provided through, for example, an emulated command line interface of the terminal application. The canary program 316 may be referenced by a path (e.g., a Linux path name) through a network interface application.

In some examples, the parameters 320 include a repeated reference to the canary program 316 to fill all parameter fields (e.g., ‘squirrelsquirrelsquirrel’). In other examples, the parameters 320 include references to different instances of the canary program (e.g., the canary program 316 with different names or aliases) corresponding to different parameter fields or offsets in order to trace which parameter field cause the call to the canary program 316 (e.g., ‘canary01canary02canary03’). Although the test tool 301 may not know the parameters expected by the application 314, in some cases the test tool 301 may know a particular format for the parameters, such as eight-character parameters, one-byte parameters, etc. Thus, knowing the parameter format, the test tool 301 can fill the parameters with references to the canary program 316 to determine whether the parameters cause the application 314 to call the canary program 316.

The method of FIG. 3 also includes calling 306, by the application 314, the canary program 316 in response to receiving the call 322 from the test tool 301. In some examples, the application 314 may be configured to receive a particular parameter for calling another program. Thus, if the reference to the canary program 316 is supplied as that particular parameter, the application 314 will call the canary program 316. For example, an authorized program may be configured to receive a particular parameter indicating a program to be called during an exit routine, which may be carried out in response to an abnormal end or error condition of the authorized program. Continuing this example, if the authorized program abnormally ends, during the exit routine the authorized program will call the canary program 316 when a particular parameter includes a reference to the canary program 316.

The method of FIG. 3 also includes recording 308, by the canary program 316, that the canary program 316 has been called by the application 314. In some examples, the application 314 is an authorized program. In other examples, the application 314 is a network interface application (e.g., a web application). In the absence of a security vulnerability, it is not expected that the canary program 316 will be called or executed, as the canary program 316 provides no function other than identifying a security vulnerability. Thus, in response to being called by the application 314, the canary program 316 will execute and make a record of the call that can signal to the test tool 301 or a test engineer that the canary program has been called. In some examples, the canary program 316 records 308 that the canary program 316 has been called by the application 314 by writing an entry in a table 324 or other data structure that can be read by the test tool 301. For example, the entry may include circumstances of the call to the canary program such as the timestamp of the call, the name of the authorized program that issued the call, the load module and offset that called the canary program, endpoints or uniform resource locators (URLs) of the call when made through a web interface, as well as whether it was the canary program 316 was running in supervisor state, system key, or with the JSCBAUTH bit set, or any combination. In some examples, the canary program 316 may also record the home, primary, and secondary address space in which this occurred. In some examples, the canary program 316 may trigger a system dump.

The method of FIG. 3 also includes determining 310, by the test tool 301, whether the application 314 called the canary program 316. In some examples, the test tool 301 determines 310 whether the application 314 called the canary program 316 by inspecting the table 324. Based on the information in the table 324, the test tool 301 can determine the test that made the call 322 and thus the list of parameters that was provided to the application 314 that resulted in the application 314 calling the canary program 316. If unique canary program names or aliases are provided as parameters, the test tool 301 can further determine which parameter in a parameter string resulted in the canary program 316 being called. In one example, the test tool 301 inspects the table 324 after each test attempt to determine if the canary program 316 was called. In another example, the test tool 301 can determine, from the table 324, the time that the canary program 316 was called and the application that call it, and correlate that time to the test that made the call 322 to the application 314.

The method of FIG. 3 also includes logging 312, by the test tool 301, a security vulnerability of the application 314 in response to determining that the application 314 called the canary program 316. In some examples, the test tool 301 logs 312 the security vulnerability by recording that a particular call to an authorized program with a particular parameter or list of parameters presents a security vulnerability, such as a result in which a program is executed with escalated privileges and/or with unexpected input. In some examples, the test tool 301 logs the information that information that was obtained from the table 324, such as the time of the call, the name of the application that issued the call, the load module and offset that called the canary program 316, endpoints or URLs of the call when made through a web interface, inputs received from the application, as well as whether the canary program 316 was running in supervisor state, system key, or with the JSCBAUTH bit set, or with some other escalated privilege. In some examples, the test tool 301 may also log the home, primary, and secondary address space in which this occurred. In some examples, the test tool 301 may log the results of system dump triggered by the canary program 316, such as the name of the dataset that includes the system dump.

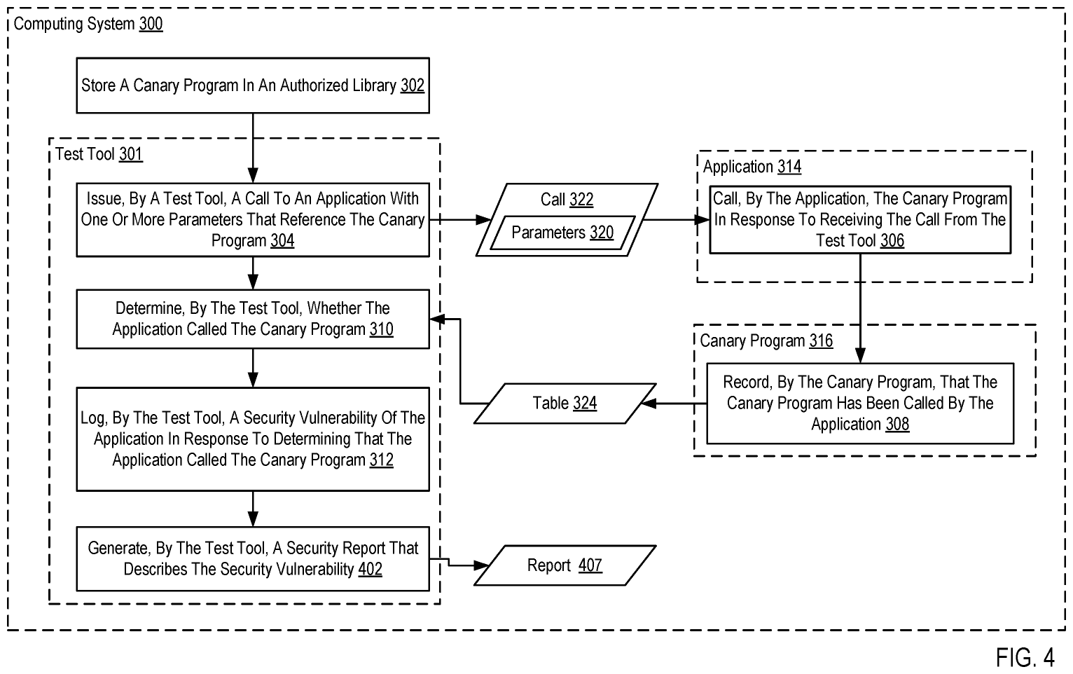

For further explanation, FIG. 4 sets forth a flow chart of another example method of detecting security vulnerabilities through dynamic testing with canary programs in accordance with at least one embodiment of the present disclosure. The method of FIG. 4 extends the method of FIG. 3 in that the method of FIG. 4 further includes generating 402, by the test tool 301, a security report 407 that describes the security vulnerability. In some examples, the test tool 301 generates a report 407 that identifies the name of the application that issued the call, the parameter string or parameter file, the load module and offset that called the canary program 316, endpoints or URLs of the call when made through a web interface, inputs receive from the application, as well as whether the canary program 316 was running in supervisor state, system key, or with the JSCBAUTH bit set, or with some other escalated privilege. In some examples, the test tool 301 stores the security report 407 in a file or data set that is restricted to access by authorized users due to the sensitive nature of the results, or writes the security report 407 to a system log. In some examples, the security report 407 is accompanied by an alert to a user or administrator. For example, the security report 407 may be provided in a user interface that presents the user or administrator with options such as removing the authorized program. A user can provide the report to the developer of the authorized program or web application so that the developer can fix the problems, such as by restricting the programs that can be called by the application to a specific list of programs or by altogether removing the ability of the user to specify programs that can be called by the application.

A test tool in accordance with at least one embodiment of the present disclosure detects cases in which an authorized programs allows a user to specify a program name such that the authorized program will load and call that program without knowing if the program is prepared to be called in that environment or with the input that it is providing. In such cases, the authorized program should be making sure that program is in a list of programs that expected to be called in an authorized environment with input in the format the authorized program will provide. Otherwise, the called program called could take some action that violates system integrity such as writing to storage or branching to an address.

A test tool in accordance with at least one embodiment of the present disclosure detects actual privilege escalations by determining that the system has granted a user elevated privilege, not simply using canary values to test software function or analyzing program exceptions. The test tool does not need to know in advance if an application will be invoked or how it will be invoked, so instead of testing one application at a time the test tool can test the entire operating system environment and applications to see if and how a canary program gets control in order to determine what privileges it receives. The test tool detects a security weakness that can be resolved to prevent malicious activity or unintended consequences, as opposed to identifying those consequences or detecting suspicious activity after they have already occurred.

A test tool in accordance with at least one embodiment of the present disclosure detects whether a parameter can be supplied to a network interface application, such as a web application, through the network interface that will cause the network interface application to call another program. Thus, the test tool can detect a security weakness of the network interface application that can be resolved to prevent malicious activity or unintended consequences, as opposed to identifying those consequences or detecting suspicious activity after they have already occurred.

In view of the explanations set forth above, readers will recognize a number of advantages of detecting security vulnerabilities through dynamic testing with canary programs according to embodiments of the present disclosure including:
Identifying security vulnerabilities where a program may be called with elevated privileges but without adequate checks on inputs or environment.
Detecting complex security weaknesses where intended interfaces such as parameter strings and configuration files can create unintended security vulnerabilities if they allow programs specified by the user to get control with elevated privilege.
Proving that intended interfaces can be manipulated to provide a user with more authority or privileges than their credentials allow.

Exemplary embodiments of the present disclosure are described largely in the context of a fully functional computer system for detecting security vulnerabilities through dynamic testing with canary programs. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of detecting security vulnerabilities through dynamic testing with canary programs, the method comprising:
storing a canary program;
issuing, by a test tool, a call to an application with one or more parameters that reference the canary program;
determining, by the test tool, whether the application called the canary program; and
logging, by the test tool, a security vulnerability of the application in response to determining that the application called the canary program.

2. The method of claim 1, wherein the application is one of an authorized program and a network interface application.

3. The method of claim 1, wherein the one or more parameters each reference the canary program.

4. The method of claim 1, wherein the one or more parameters each reference different canary programs.

5. The method of claim 1, wherein the security vulnerability indicates that the canary program received an elevated privilege.

6. The method of claim 1 further comprising:
calling, by the application, the canary program in response to receiving the call from the test tool.

7. The method of claim 1 further comprising:
recording, by the canary program, that the canary program has been called by the application.

8. The method of claim 6, wherein the canary program writes a record to a table, wherein the record includes one or more of: a timestamp of the call, a name of the application that called the canary program, a load module and offset that called the canary program, endpoints of the call, inputs received from the application, and an indication of an escalated privilege.

9. The method of claim 1 further comprising:
generating, by the test tool, a security report that describes the security vulnerability.

10. An apparatus for detecting security vulnerabilities through dynamic testing with canary programs, the apparatus comprising a computer processor, a computer memory operatively coupled to the computer processor, the computer memory having disposed therein computer program instructions that, when executed by the computer processor, cause the apparatus to carry out the steps of:
storing a canary program;
issuing, by a test tool, a call to an application with one or more parameters that reference the canary program;
determining, by the test tool, whether the application called the canary program; and
logging, by the test tool, a security vulnerability of the application in response to determining that the application called the canary program.

11. The apparatus of claim 10, wherein the application is one of an authorized program and a network interface application.

12. The apparatus of claim 10, wherein the one or more parameters each reference the canary program.

13. The apparatus of claim 10, wherein the one or more parameters each reference different canary programs.

14. The apparatus of claim 10, wherein the security vulnerability indicates that the canary program received an elevated privilege.

15. The apparatus of claim 10 further comprising:
calling, by the application, the canary program in response to receiving the call from the test tool.

16. The apparatus of claim 10 further comprising:
recording, by the canary program, that the canary program has been called by the application.

17. The apparatus of claim 16, wherein the canary program writes a record to a table, wherein the record includes one or more of: a timestamp of the call, a name of the application that called the canary program, a load module and offset that called the canary program, endpoints of the call, inputs received from the application, and an indication of an escalated privilege.

18. The apparatus of claim 10 further comprising:
generating, by the test tool, a security report that describes the security vulnerability.

19. A computer program product for detecting security vulnerabilities through dynamic testing with canary programs, the computer program product disposed upon a computer readable medium, the computer program product comprising computer program instructions that, when executed, cause a computer to carry out the steps of:
issuing, by a test tool, a call to an application with one or more parameters that reference a canary program;
determining, by the test tool, whether the application called the canary program; and
logging, by the test tool, a security vulnerability of the application in response to determining that the application called the canary program.

20. The computer program product of claim 19, wherein the security vulnerability indicates that the canary program received an elevated privilege.
